(19) United States
(12) Patent Application Publication
(10) Pub. No.: US 2005/0267605 A1
(43) Pub. Date: Dec. 1, 2005

(54) Home entertainment, security, surveillance, and automation control system

(76) Inventors: Paul K. Lee, Arcodia, CA (US); Xiuyan Zhang, Richardson, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 11/030,262

(22) Filed: Jan. 6, 2005

Related U.S. Application Data
(60) Provisional application No. 60/534,736, filed on Jan. 7, 2004.

(51) Int. Cl. G05B 11/01; G05B 15/00

(52) U.S. Cl. 700/19; 340/310.11

(57) ABSTRACT

A system and method of home entertainment, security, surveillance, and automation control includes a plurality of remote devices, a display device, and various user input devices capable of receiving a home user's commands. The system further includes a main control unit capable of controlling and programming the system, and a communication link capable of transferring various data and control signals between the main unit and the plurality of remote devices. The home user's command enables to select the remote devices, to transmit various automation control signals, and to establish exchanges of various data between the main control unit and at least one of the plurality of remote devices. Finally, the communication link between the main control unit and the remote devices includes power line communication network over existing home AC power line. The home user is also able to control and communicate with the system at remote location over the Internet.

### CROSS-REFERENCE TO RELATED APPLICATIONS

Provisional Application No. 60/534,736

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to home electronic system for entertainment, security, surveillance, automation control, and communication, local home network or via Internet, and more particularly to home security, surveillance, and automation control system capable of controlling home electronic devices from remote location, retrieving information from a plurality of cameras and sensors, and transmitting audio, video, and control signals between a main control unit of the home system, a user input device, and at least one remote home electronic device via power line communication network or wireless network.

2. Description of Related Art

Over the last few years, there has been a growing demand for home electronic devices, such as entertainment devices, home network devices, security devices, and automation control devices.

There are more and more such devices and systems installed within homes and buildings. It is tough job to install, optimize, control, and maintain the devices and systems. Those devices and systems also required additional new wires to setup and connect to its subsystems.

The most of home electronic devices and systems installed now do not have the ability to be controlled by remote user via Internet or home network. The systems and devices do not take advantage of TCP/IP network.

The most of home security surveillance systems installed do not take advantage of video surveillance. A user may get security video surveillance system and service from a security companies, but the systems are more expensive and complex. It is needed to add extensive new wire for the user to install this security system.

The use of video and audio devices, such as video and audio conferencing devices, video and audio intercom devices, and camera devices, has increased dramatically in recent years.

When these audio and video devices are integrated into an existing house or building, the installation of new control wires can be very complicated and costly. There is an ever-growing need for transmitting live video, audio, and control data between different rooms or locations in the house or building or at remote locations via Internet, such as home video-audio intercom communication, real-time video-audio chat via Internet, video conference, video surveillance, and TV/DVD entertainment program.

The conventional home automation control devices are very complicated to control. In addition, the home control devices also need the installation of a discrete set of control wires and a user house will be damaged.

Power line communication systems and method have been used in a variety of applications, such as control of home lights, door openers, and electrical switches for many years. Power line communication systems and method are relatively inexpensive and reliable.

There are many different protocols to provide power line communications.

### BRIEF SUMMARY OF THE INVENTION

It would be advantageous if a home system including TV, DVD, a video-audio intercom, a security, a video surveillance, baby care and childcare, and home control. It is an all-in-one system.

As a result, it is difficult for conventional home electronic systems to assist the home user in carrying out daily activities without this all-in-one system.

Accordingly, it would be desirable to provide an improved and multifunction home electronic system for entertainment, security, and automation control. This all-in-one system is more flexible and simpler to install and use than conventional systems. Moreover, the system takes advantage of power line communication without new wire and can be controlled over Internet or home network.

The present invention is directed to provide a system and method of controlling remote home electronic devices coupled to home network and transmitting audio, video, control data between a main home control unit, user input device, and at least one remote home electronic device using power line communication or wireless communication that provide no new wire connection.

For the most part, this invention takes advantage of existing home power wiring to transmit audio, video, and control data. The power line communication provides a best solution for user to install, setup, and use new home devices without new wiring in home or building. Not all the embodiments of the invention are restricted in to the power line communication. In order to take advantage of legacy audio-video devices, such as wireless camera, the present invention also provides wireless communication to transmit audio, video, and control data.

Another object of the present invention is to provide remote control and data transfer over Internet or home network for user to monitor user home, control home electronic devices, and communicate with the devices while user is at remote location via Internet.

Another object of the present invention is to provide a multifunction home electronic system that has entertainment modules, security and surveillance devices, automation control devices, and home communication devices, such as home video-audio intercom. The system should be easily installed and maintained.

Another object of the present invention is to provide easily installation, maintenance, and operation. In addition, the system can be easily upscale or downscale according to user desire.

Additional advantages, objects, and features of the invention will be set forth in part in the description which follows.

In another aspect of the present invention, there is provided an integration of the system for home entertainment, security, surveillance, automation control, and communication with existed home electronic devices using power line communication interface device via power line home network.

In a further aspect of the present invention, a method in controlling and operating a system for home entertainment, security, and automation control is provided. According to the method of the present invention, a user may select and control the system to provide entertainment or security or and automation control function using a user input device, such as remoter controller, cell phone, wireless PDA, and PC via Internet.

In yet another aspect of the present invention, a baby watcher and childcare remote devices are provided which monitor and watch baby or child. In the illustrated embodiment, the devices comprise a camera and a plurality of sensors. A main control unit receives live video and audio data from these devices via power line communication link and sends the data to the display device. The video and audio data may be received from remote location via Internet.

In still another aspect of the present invention, there is provided a security and surveillance device, including a plurality of sensors and cameras installed in correspondence to a place to be monitored for detecting information about intruder, a device processing unit and a communication interface that is connected to at least one of the plurality of sensors and cameras and communication network for transmitting detecting information to a main control unit of the system via the communication network.

In another aspect of the present invention, home automation control remote devices are provided, including a plurality of light or switch control devices, an A/C control device, a sprinkler control device, door/gate control, VCR control, and a damper control device. Each device comprises a power line communication interface and control module. The device receives data or control signals from a main control unit via communication network, such as power line communication or wireless communication.

In still another aspect of the present invention, there are also provided a plurality of video and audio remote devices, comprising a plurality of audio-video intercom devices, audio intercom devices, a plurality of power line speakers, and a plurality of power line phone devices, wherein the devices comprising a power line communication interface. The first power line phone device sends and receives audio data from a main control unit of the system or second power line phone device via power line communication. The power line speakers comprising a speaker and a power line communication interface module receive audio signals from the main control unit via power line communication network. The first audio-video intercom device transmits audio and video data to and from a main control unit of the system or second power line phone device via power line communication.

In another aspect of the present invention, there is provided an entertainment module, comprising TV/cable TV module, DVD/VCD player module, and Radio tuner.

In another aspect of the present invention, there is provided an audio-video recorder, comprising hard drive capable of recording audio and video data. Thus, with the recorder, a user may record TV, DVD, and Radio program for later viewing. Further, the live video data from surveillance camera or other camera can be recorded and the user has a chance to review them later. In addition, the audio-video data file downloaded from Internet, video-audio intercom, and telephone also can be recorded.

It is to be understood that both the foregoing general description and the following detailed description of the present invention are exemplary and explanatory and are intended to provide further explanation of the invention as claimed.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a schematic illustration of a home entertainment, security, surveillance, and automation control system over home network communication link according to an example of the present invention;

FIG. 2 is a functional block diagram of a main control unit in accordance with an exemplary embodiment of the present invention;

FIG. 3 depicts a display device formed by a LCD screen, two speakers, and one camera according to the invention;

FIG. 4 depicts a remote controller according to the invention;

FIG. 5 depicts one embodiment of baby watcher device according to the invention;

FIG. 6 is another embodiment of baby watcher device according to the invention;

FIG. 7 depicts one embodiment of childcare device according to the invention;

FIG. 8 is another embodiment of childcare device according to the invention;

FIG. 9 illustrates one embodiment of surveillance and security device according to the invention;

FIG. 10 illustrates another embodiment of surveillance and security device according to the invention;

FIG. 11 shows a block diagram of Light switch control device according to the invention;

FIG. 12 shows a block diagram of sprinkler control device according to the invention;

FIG. 13 shows a block diagram of AC control device according to the invention;

FIG. 14 shows on screen program menus;

FIG. 15 shows a block diagram of power line phone device according to the invention;

FIG. 16 shows a block diagram of smart plug and Power speaker device according to the invention;

FIG. 17 shows a block diagram of audio-video intercom device according to the invention;

FIG. 18 shows a block diagram of audio intercom device according to the invention;

FIG. 19 shows a block diagram of damper control device according to the invention;

FIG. 20 shows a block diagram of door and gate control device according to the invention;

FIG. 21 shows a block diagram of three wireless remote devices interacting with the main control unit;

FIG. 22 shows a flow chart illustrating a method of implementing the present invention for home entertainment, security, surveillance, automation control system over home network communication link;

### DESCRIPTION OF THE PREFERRED EMBODIMENT

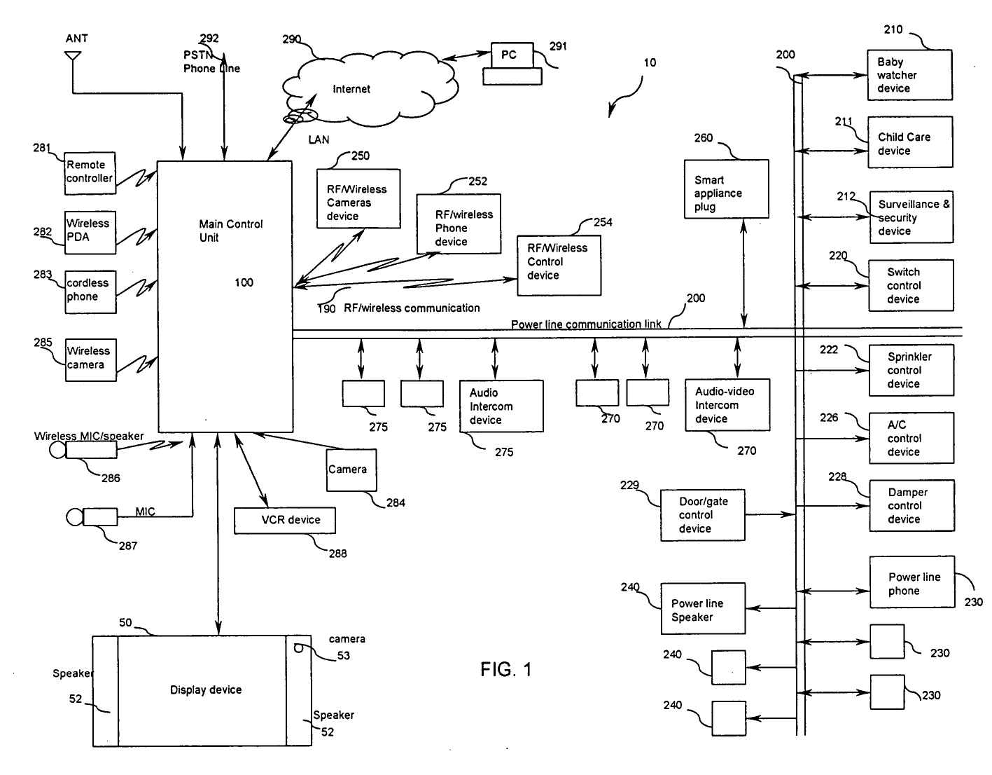

Referring now to the drawing, and in particular to FIG. 1, a preferred embodiment of a system 10 for home entertainment, audio/video communication, security, surveillance, and automation control. The system 10 illustrated generally includes a plurality of remote devices that are capable of video, audio, and control communication; a display device 50 that is capable of displaying text and image data; a plurality of user input devices that are capable of receiving commands from a user; a main control unit 100 that is capable of enabling a user to set, program, and control the system, receiving various data from at least one remote device or from one of user input devices, and sending the audio-video data to the display device or the control data to at least one remote device; and a communication link 200 that is capable of transmitting various data including text, image, voice, and control data between the main control unit and at least one remote device.

The plurality of remote devices include: a baby watcher 210; a childcare device 211; surveillance and security device 212; a switch control device 220; a sprinkler control device 222; an A/C control device 226; a damper control device 228; power line phone 230; power line speaker 240; door/gate control device 229; at least one smart appliance plug 260; at least one audio-video intercom device 270; at least one audio intercom device 275; at least one wireless control device 254; a RF/wireless phone device 252; and a wireless camera and sensor device 250. The audio, video, and sensor data are received and transmitted between the main control unit and various remote devices via power line communication link and/or RF/wireless communication.

The user input devices include a remote controller 281, a wireless PDA 282, a cell phone 283, a remote computer 291, a camera 284, a wireless camera 285, a wireless microphone and speaker 286, a microphone 287, and a VCR 288. The user input devices receive user commands or user control signals and then transmit them to the main control unit 100. Further, the remote controller 281, the wireless PDA 282, the cordless phone 283, and a wireless microphone 285 wirelessly send user control signals to the main control unit.

A user sends control signals to the main control unit 100 by pressing keys buttons provided on one of a remote control 281, cell phone 283, and wireless PDA 282. A user sets the main control unit to different mode by pressing a corresponding button provided on the user input device. The main control unit may receive audio, video, and control data or signals from the digital camera or webcam 284, microphone 287, cable modem, and telephone line. There is interface connected to cell phone, not shown in FIG. 1. There is another interface connected to PDA, not shown in FIG. 1.

The microphone 287 sends audio data to the system via wired connection for audio communication. Based on the microphone 287 or wireless microphone 286 and speaker 286, the user may implement audio communication, such as the running Internet voice chat, audio intercom, audio-video intercom, and making telephone call. Further, the user may use wireless microphone and speaker 286 to implement audio communication while the user is preparing a dinner in the kitchen of a home.

The remote computer 291 is interactive and interoperable with the main control unit 100 for audio, video, sensor, and control data communication through external Internet network 290 or Public Switched Telephone Network 292. The remote computer comprises application software that is capable of control the computer to receive audio, video, and sensor data from the system and send control data to the system.

The system is also provided the ability to implement audio-video two way communications with remote PC 261, such as video conference or Internet audio-video chat. Additionally, the application software is needed to run such program.

Turning to FIG. 1 and FIG. 14, preferably, the remote controller 281 is provided to control the system 10. The wireless PDA 282 and the cell phone 283 are also provided the ability to control the system. A user may program the system via on-screen program menus.

Referring again to FIG. 1, the main control unit 100 generates a control signal for controlling at least one remote device, such as surveillance & security 212, and handling video, audio, and sensor data from the remote device.

The communication link 200 is power line communication network that is capable of transmitting various data via power line without additional hardwire connection. The protocols used include home plug 1.0, X10, and CEbus.

In addition, the RF/wireless communication 190 is employed to implement audio, video, sensor, and control data communication between the main control unit 100 and at least one RF/wireless remote device, such as the wireless camera device 250.

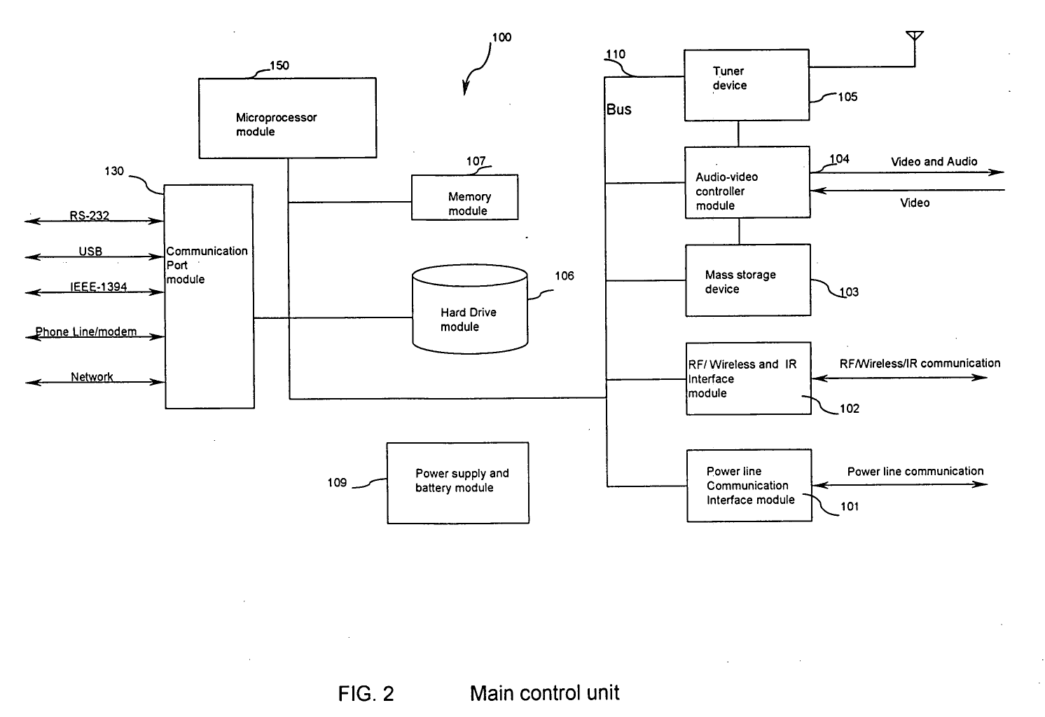

Turning to FIG. 2, the main control unit 100 is multifunction system. The main control unit is configured to control the system and perform communication with at least one of the plurality of remote devices and user input devices via the power line communication link or wireless communication link. The main control unit 100 comprises hardware and software that control the processing of data to and from the unit.

The main control unit 100 includes: a system and data bus 110 for transmitting data and system control signals between the modules; a microprocessor 150 which is connected to the bus; a mass storage module 103 that is connected to the microprocessor over the bus; a tuner module 105 that is coupled to the microprocessor; an audio-video controller module 104 that is connected to the microprocessor over the bus; a wireless and IR interface module 102 that is connected to the microprocessor over the bus; and a power line communication interface module 101 that is connected to the microprocessor over the bus.

In addition, the main control unit 100 also includes: a hard drive 106 that is capable of storing system and application software; a memory 107; a communication port module 130; and a power supply and backup battery module 109.

Basically, the microprocessor 150 is capable of executing instruction stored in the memory 107 or user command to control the system 10 and provide functionality including that provided by certain embodiments of the present invention.

The memory 107 includes RAM, ROM, and EEPROM. Typically it is capable of storing boot code instructions or other system information.

The communication port module 130 includes: a RS-232; USB 2.0 whose rate is 480 Mbps; 1394 whose rate is 400 Mbps; a DVI, a phone port; and Ethernet port. Preferably, the communication port module, the Ethernet port and the phone port, allows connection to an Ethernet based network, such as a broadband connection to a WAN or the Internet. The RS-232 port is legacy port that allows connection to various electronic devices. Further, the IEEE-1394 port allows connection to external audio-video device and the DVI port communicates with external video device.

The system provides real-time Internet connectivity to external network, such as WAN. The Internet connectivity includes PSTN and Ethernet. For example, based on the communication port module, the PSTN telephone jack and the Ethernet port are provided in order to communicate with remote PC 291 and Internet. A user may use Broadband to transmit various data to Internet via Ethernet port. The slow connection uses dial-up ISP via phone line jack to transmit various data. In addition, the user also may make phone call via the wireless MIC and speaker 286 or audio intercom device 275 or power line phone 230.

The hard drive 106 is configured to store operating system, various application software, and database for the plurality of remote devices.

In addition, the mass storage module 103 comprises: a hard drive; a flash memory; and a DVD random access memory. Preferably, the module has the ability to record various data and play the data back later. The data include: at least one of the remote devices, such as the surveillance and security device or the baby watcher device; the audio-video intercom device; the audio intercom device; the power line phone device; one of the user input devices, such as cordless phone 283; TV and Radio module; and audio-video file from the Internet. With the mass storage module, the user may record favor TV or play DVD/VCD program. In addition, the telephone calls, audio-video data from the intercom device or power line device, and audio-video files downloaded from the Internet can be recorded to the mass storage module. Finally, the mass storage module is provided to record video, audio, and sensor data from at least one of the surveillance and security devices.

The DVD random access memory in the module 103 is coupled to the microprocessor 150 via the bus 110 and designed for playing digital versatile disk (DVD) and video compact disk (VCD). With the DVD random access memory, the user may enjoy DVD and VCD programs using LCD display device 50.

The TV and Radio tuner module 105 is coupled to the microprocessor via the bus and designed for receiving TV, cable TV, and Radio signals. The TV and Radio tuner module is capable of receiving broadcasting signals, such as TV, cable TV, and Radio.

The TV and Radio tuner 105 receives various broadcasting signals includes cable and satellite signals. A user may set system 10 to TV or Radio mode, and then the main control unit sends signals to the tuner module and video-audio controller. On the other hand, the video and audio signals are outputted through the LCD display 50 and speaker 53, respectively. The display device can also receive signals from DVD/VCD player module 103 if a user sets the main control unit to DVD/VCD player mode. The system 10 will work as home entertainment center now.

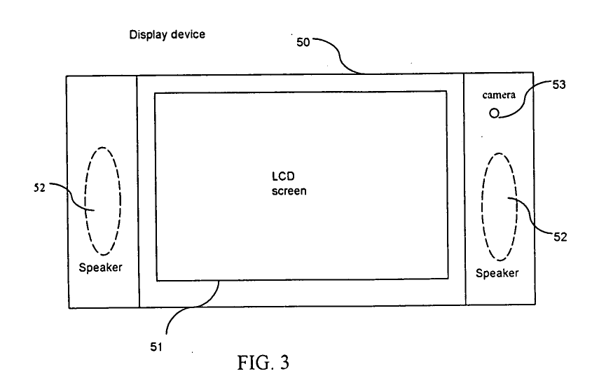

The audio-video controller module 104 is coupled to the microprocessor, the DVD module, and the TV and Radio tuner module via the bus. The controller interface module is capable of receiving signals from the bus, the DVD module, and the TV and Radio tuner module, and then sending audio and video data to the LCD display device to display associated images and texts. The control module also receives video data from the camera 53 in LCD display device 50, in FIG. 3.

The RF/wireless and IR interface module 102 is coupled to the bus 110 and configured to transfer various data to the microprocessor. The protocols of the interface module 102 comprise an IEEE 802.11 standard to implement wireless communication and cordless telephone standard. The interface module 102 also includes an IR and RF transceiver that is capable of wirelessly sending and receiving various data between the module 102 and at least one of user input devices. The interface module receives control signals from the remote controller or the cell phone or a wireless PDA and then the microprocessor outputs a control signal to perform a desired function in response to the user signals.

On the other hand, the interface module 102 is configured to provide an interface between the main control unit and at least one of the remote devices, such as the baby watcher device 210. The module wirelessly receives video, audio, sensor, and control data from at least one of the plurality of wireless remote devices, such as RF/wireless camera 250. Meanwhile, the module sends control data to at least one of the devices. For example, the module sends control signals to the wireless control device 254 to control lamp. Finally, in order to use the interface module 102, the associated software driver is also provided.

The power line communication interface module 101 is coupled to the bus and configured to transfer audio, video, sensor, and control data between the power line communication interface module and at least one of the plurality of remote devices, such as surveillance and security device over the power line communication link. The power line communication interface module is capable of providing one or more communication protocols such as power line home plug 1.0, X10, and CEbus.

Referring to FIG. 1 and FIG. 3, a display device 50 according to the present embodiment includes a LCD display screen 51, two speakers 52, and a camera 53. The display device will receive audio and video data from the main control unit 100 or TV and Radio tuner module or DVD/VCD player module, in FIG. 2. The camera 53 is capable of sending video data to the main control unit. With the display device 50, a user may watch TV, DVD, and VCD program. On the other hand, the display device 50 displays live image from the cameras in the remote devices such as the surveillance and security device, the baby watcher device, the childcare device, and the audio-video intercom device. Additionally, the display device 50 displays live images from the Internet.

In the case where the user selects to program the system, the display device 50 will show on screen program menus, in FIG. 14.

The main control unit 100 may be configured to send control signals to the VCR 288 via IR communication. Examples of such include controlling VCR to play or record predetermined program at local or remote location via the Internet 290. In addition, the main control unit 100 may also be configured to receive audio and video data from the VCR 288 via the communication port module 130. For example, a user may watch the programs from the VCR VHS and/or copy it.

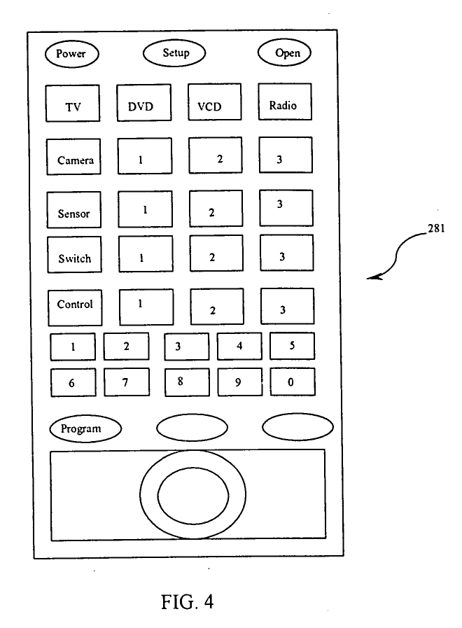

FIG. 4 illustrates the remote controller 281. The system 10 receives the user command signals from the remote controller 281 to control at least one of the plurality of remote devices or the system 10. For example, a user may switch the camera in Surveillance and security device on or off, or place the camera in standby mode. Similarly, the user may program the system or turn on or off the system using the remote controller

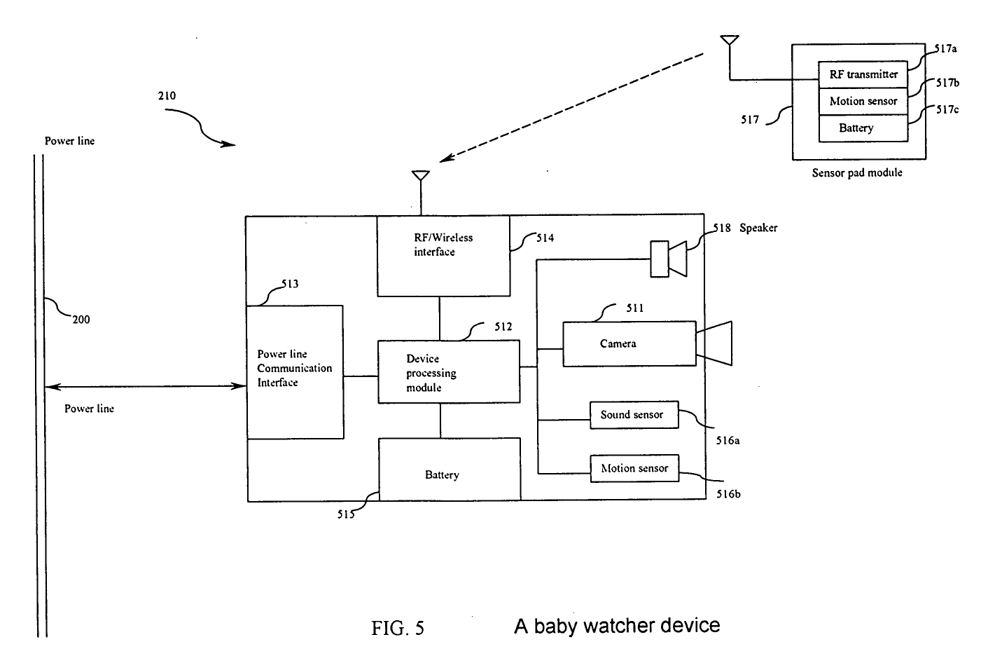

Turning to FIG. 5, one of the remote devices is, for example, a baby watcher device 210. It includes a camera 511 with infrared lighting, a speaker 518, a high-quality sound sensor 516a capable of detecting baby's sound motion, a motion detector 516b capable of detecting baby's motion, and an extremely sensitive motion sensor pad module 517 capable of detecting baby's motion. It further includes: a device processor module 512; a power line communication interface module 513 that is coupled to a power line communication link that is capable of transmitting audio, video, sensor and control data through power line network to the main control unit 100; a RF/wireless interface module 514 that is capable of remotely receiving signals from the sensor pad module 517; and a battery 515.

The sensor pad module 517 includes an RF/wireless transmitter 517a, an extremely sensitive motion sensor 517b, and a battery 517c. Based on the present invention, the sensor pad module 517 wirelessly transmits the sensor data to the baby watcher device 210 via the RF/wireless interface 514.

The power line communication interface module 513 is capable of transmitting various data to and from the main control unit 100 via power line communication. The audio, video, and sensor data are transferred from the sensor pad module 517, the sensor 516a, the sensor 516b, and the camera 511 to the device processing module 512. Further, after processing the data, the processing module 512 will send the data to power line communication interface module 513. On the other hand, the main control unit 100 receives audio, video, sensor data from power line communication interface 513 via power line communication and sends audio-video data to the display device 50. For example, a user may monitor a baby's room and watch the baby live image anywhere in the home.

Finally, the device processing module 512 causes operation of camera 511 based on the data received from the sensor pad module 517, the sensor 516a, and the sensor 516b, and instruction from the main control unit 100 via power line communication. For example, a user may send control signals to control the camera 511 or audio signals to speaker, such as music.

Generally, a user may set the main control unit to a remote device mode, such as baby watcher, for interacting with the remote device for performing various related functions. The photographic operation is preformed in accordance with an instruction from the main control unit 100. The module 210 detects baby's slightest movements and alerts you if a baby goes absolutely still. Baby watcher's camera has infrared lighting so a user can watch the baby day and night. If the baby cries and moves, the sound and motion sensor will be trigged. The camera will be activated and live images will send to the main control unit. Ultra-thin sensor pad module is under baby's mattress to detect baby's slightest movements. If baby wiggles completely off of the sensor pad and gets too close to the sides of the bed, the alarm will be trigged. The sensor pad module sends signal to the main control unit via wireless communication link. If there is no movement or if baby should stop moving after some seconds, an alarm sounds will be on, and the display device 50 shows live images. Mom may watch her baby from the display screen in the kitchen and monitor for motion that may occur in baby's room.

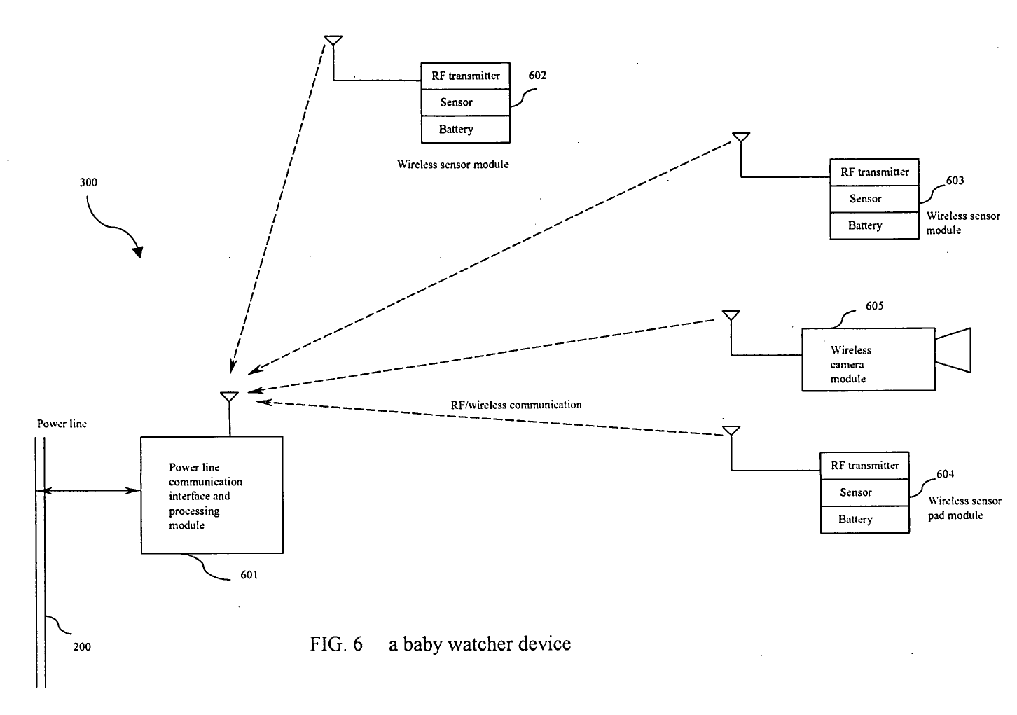

FIG. 6 illustrates another embodiment of a baby watcher device 300. The baby watcher device includes: a power line communication interface and processing module 601; a wireless camera 605 that is configured to wirelessly send video and audio data to the communication interface and processing module 601; first wireless sensor module 602; second wireless sensor module 603; a sensor pad module 604.

The wireless camera 605 with infrared lighting is capable of sending video and audio data to the communication interface module 601. The main control unit receives the video and audio data from power line communication interface and processing module 601 via RF/wireless communication 605 and power line communication 200.

The wireless sensor modules, such as the module 602 and the module 603, that are configured to wirelessly send sensor data to the communication interface and processing module 601 include a RF transmitter, a sensor, and a battery. The first wireless sensor module 602 includes a high quality sound sensor that is capable of detecting baby's sound motion. The second wireless sensor module 603 includes a motion sensor that is capable of detecting baby's motion. The sensor pad module 604 includes an RF/wireless transmitter, an extremely sensitive motion sensor pad, and a battery. It wirelessly transmits sensor data to module 601 via a RF transmitter. The communication interface module 601 wirelessly receives video, audio, and sensor data from the wireless camera 605 and the wireless sensor modules, and then sends the data to the power line communication link 200, and then sends the data to main control unit.

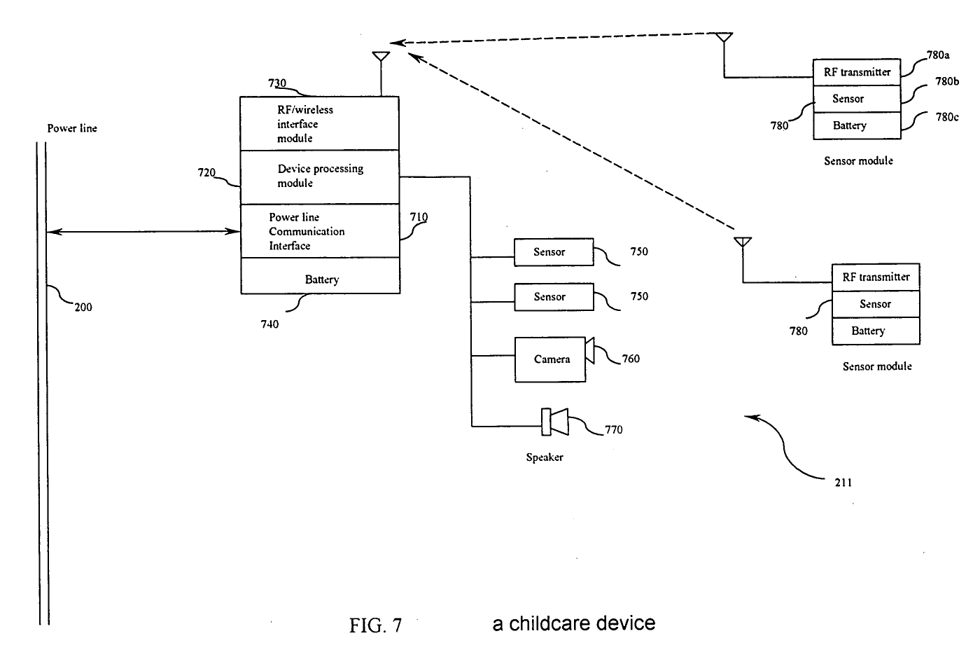

Referring now to FIG. 7, one of the remote devices is, for example, a childcare device 211. It includes: one camera 760 with infrared lighting; one speaker 770, one or more sensor 750 capable of detecting child's sound and motion; and one or more wireless sensor module 780. The childcare device 211 further includes: a device processing module 720; a power line communication interface module 710 that is coupled to a communication link and capable of transmitting audio, video, and control data through power line network to the main control unit; a interface module 430 that is capable of receiving signals from the sensor module 780; and a battery 740. The sensor module 780 includes an RF/wireless transmitter 780a, a senor 780b, and a battery 780c. It wirelessly transmits sensor data to interface module 730. The sensors in the device 211 include contact sensor, motion detector sensor, and microphone sensor.

Based on the instructions received from the main control unit, the device processing module 720 receives audio, video, and sensor data received from the sensor 750 or sensor 780, and the camera 760. Further, the device processing module 720 will process the data and then send the data to the power line communication interface 710. Additionally, the main control unit receives the data via the power line communication network 200 and transmits the data to the display device.

On the other hand, the main control unit also sends control signals to the childcare device 211 to control the operation of the camera 760. Similarly, the user or the main control unit transmits audio data to the speaker 760.

For example, based on the childcare device 211 of the present invention, a user may watch and monitor his/her child. Mom can monitor her child in anther room while she is working in kitchen. The camera 760 with motion sensor and sound sensor are connected to the main control unit 100 via power line communication. Her kids may also receive mom voice via speaker 770 if needed. Working mom may also check on her child from the office if Broadband Internet is connected to the system 10, in FIG. 1. A swimming pool in the yard can present a very dangerous area for people. One of nice functions of the present invention is to monitor the pool. The sensor in the pool, such as sensor module 780 or sensor 750, will send high priority signal to the main control unit 100 if children fall into swimming pool or unusual in the pool. An Alarm will be trigged and the main control unit 100 will send high priority emergency signal to user.

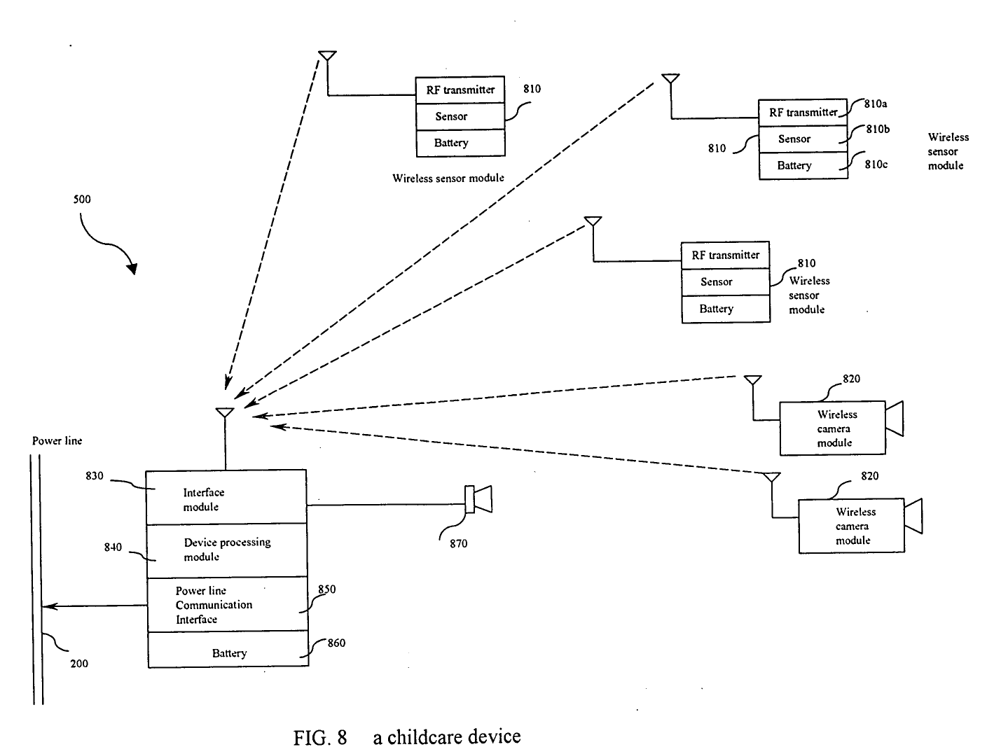

Turning to FIG. 8, there is another embodiment of a childcare device 500. The childcare device includes: one or more wireless camera 820 with infrared lighting; one speaker 870; and one or more wireless sensor module 810 capable of detecting sound and motion. The childcare device 500 further includes: a device processing module 840; a power line communication interface module 850 that is coupled to a communication link and capable of transmitting audio, video, and control data through power line network to the main control unit 100; a interface module 830 that is capable of receiving signals from the sensor module 810 and wireless camera 820; and a battery 860.

The wireless camera 820 with infrared lighting is capable of sending video and audio data to the communication interface module 830. The wireless sensor modules 810 that are configured to wirelessly send sensor data to the communication interface module 830 include a RF transmitter 810a, a sensor 810b, and a battery 810c. The sensors in wireless sensor module 810 include a high quality sound sensor that is capable of detecting child's sound motion, or a motion sensor that is capable of detecting child's motion.

The communication interface module 830 wirelessly receives video, audio, and sensor data from the wireless camera 820 and the wireless sensor modules 810, and then sends the data to the power line communication link 200 via power line communication interface module.

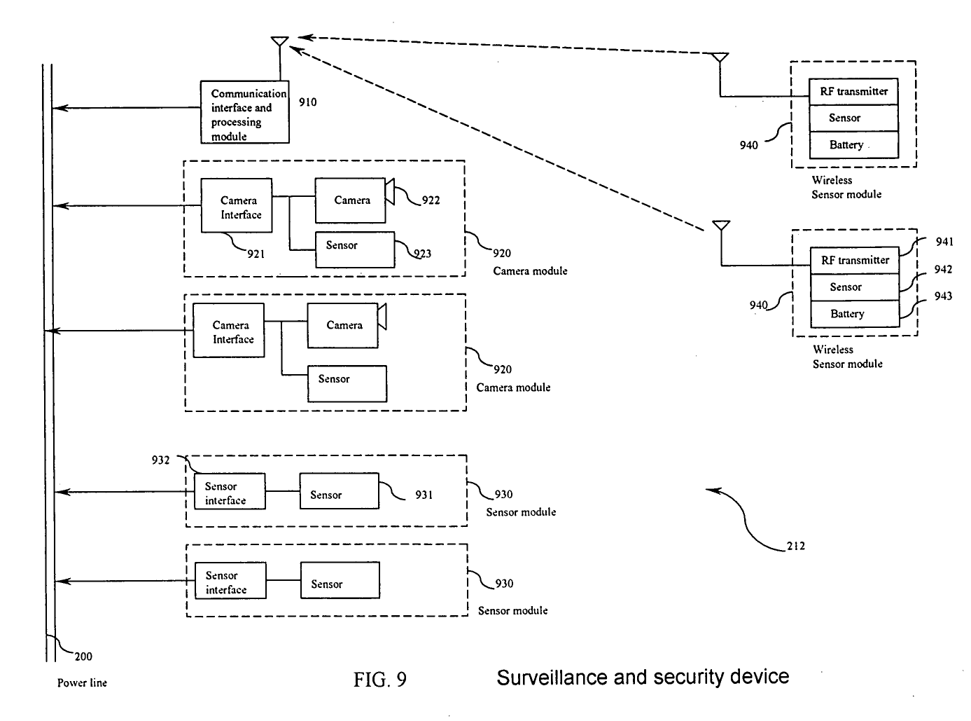

Turning to FIG. 9, one of the remote devices is, for example, surveillance and security device 212. In the surveillance and security scenario, the surveillance and security device 212 comprises: a communication interface and processing module 910 that is capable of wirelessly receiving sensor data and sending the data to the main control unit via the power line communication link 200; and at least one wireless sensor module 940 that is capable of sending senor data to the communication interface and processing module 910. Moreover, the wireless sensor module 940 further comprises a RF transmitter 941, a sensor 942, and a battery 943.

The surveillance and security device 212 further comprises at lease one power line camera module 920 and at least one power line sensor module 930. Furthermore, the camera module 920 comprises a camera interface 921, a sensor 923, and a camera 922. The sensor module comprises a sensor interface 932 and a sensor 931.

Generally, the camera module 920, sensor module 930, and wireless module 940 are installed in the necessary sites inside and outside the house. Further, there is no limitation on the number of the modules, and the number can be changed, as required.

Based on the present invention, the wireless sensor module 940 can send some information to the communication interface and processing module 910. On the other hand, the communication interface and processing module 910 can send the information to the main control unit via power line communication network. The sensor module 930 can transmit sensor data to the sensor interface module 932. Further, the sensor interface module can send the data to the main control unit via power line communication network.

According to the present invention, there are three types of setting modes of the surveillance and security device 212 for a user to select. “ON mode” is the mode that is set when the user is not present and the camera 922 is on non-stop working state. “INTERRUPT mode” signifies a state that the user is not present and the camera will be on if a trigged signal is received. “OFF mode” is the state that the surveillance and security device 212 is not working. Finally, switching of these setting modes can be performed by remote user via the Internet or local user by using the remote controller to select.

The camera 922 can communicate with camera interface 921 and then the interface sends the image data and sensor data to the main control unit 100 via power line communication network. The sensor 923 can send sensor data to the camera module 921. On the other hand, the sensor can send trigger signal to the camera 922 when the presence of an intruder has been detected by the sensor and the sensor is triggered. The camera will work on receiving the signal when the surveillance and security device 212 is set “INTERRUP mode” by a user.

The communication between the camera module 920 and the main control device can be implemented by power line communication, such as power source lines or AC lines. On the other hand, the surveillance and security device 212 can be controlled via the Internet if the system 10 is connected by broadband connections or by dial-up public telephone line connections.

The sensors in the surveillance and security device 212 comprise motion sensor, sound sensor, infrared detector sensor, contact sensor, glass-break detector, fire sensor, window vibration sensor, gas leak sensor, smoke detector, and a heat sensor.

The surveillance cameras, such as 922, can be activated when any of the sensors, such as sensor 923, is trigged. When security system has been triggered, it is preferable that surveillance and security device 212 should transmit control signal, sensor data, and video data to the main control unit 100 via power line communication network. The user will be alerted and the text message corresponding to the nature of the unusual event information sensed by the sensors is sent to the display device 50 in order to inform the user which sensor is triggered. Additionally, live image will show on user's LCD display device. The main control unit 100 can also automatically make telephone call, such as call the user mobile telephone 283, if alarm is on and the user is not at home if the user is at home. The user can also monitor remotely over the web if the system 10 is connected to the Internet.

A house or building can be provided with a plurality of the surveillance and security device 212 throughout the house or building in order to record information. With the surveillance and security device 212, user can watch live image on the LCD display to monitor the home or building by surveillance camera 922 and sensor module. The surveillance camera 922 may record audio and video data to the mass storage module 103, in FIG. 2, or user's VCR. The main control unit 100 has functions that control user's VCR to record audio-video signals from remote cameras, such as the camera 922. Additionally, the surveillance and security device 212 also allows user to monitor door and window by contact sensors, motion sensors, glass-break detectors.

The connection and communication between the main control unit 100, the cameras, and sensors are implemented by no new wire home networking technology —power line communication. With power line communication, signals travel over the existing power lines in user's home, eliminating the need for expensive rewiring. A wireless connection and communication is also employed in the surveillance and security device 212.

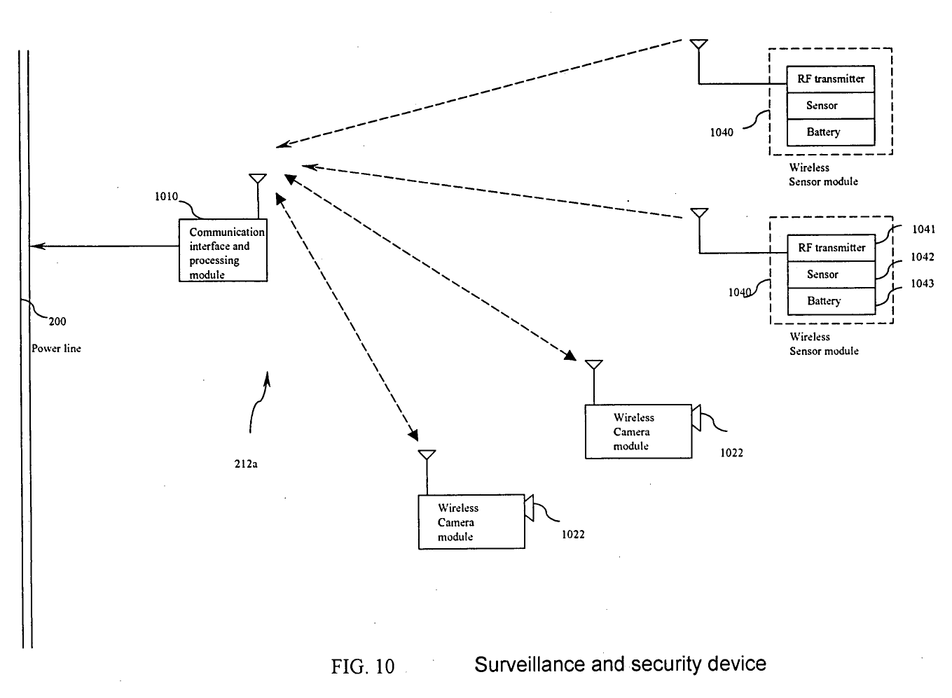

FIG. 10 illustrates another embodiment of surveillance and security device 212a. The surveillance and security device includes a communication interface and processing module 1010, at least one wireless camera 1022, and at least one wireless sensor module 1040. Furthermore, the wireless sensor module 1040 includes a RF transmitter 1041, a sensor 1042, and a battery 1043.

The sensors in the surveillance and security device 212a comprise motion sensor, sound sensor, infrared detector sensor, contact sensor, glass-break detector, fire sensor, window vibration sensor, gas leak sensor, smoke detector, and a heat sensor.

According to the embodiment of present invention, the wireless sensor module 1040 can transmit sensor data to the communication interface and processing module 1010. The communication interface and processing module 1010 will send the data to the main control unit via power line communication network. Further, the wireless camera module 1022 will wirelessly communicate with the communication interface and processing module 1010. The operation of the wireless camera 1022 is controlled by the main control unit. The communication interface and processing module 1010 sends video, audio, sensor data to the main control and receive control signal from the main control unit via power line communication network.

The surveillance and security device 212a can also be controlled via the Internet if the system 10 is connected by broadband connections or by dial-up public telephone line connections.

The sensors in the surveillance and security device 212a also comprise motion sensor, sound sensor, infrared detector sensor, contact sensor, glass-break detector, fire sensor, window vibration sensor, gas leak sensor, and a heat sensor.

Turning to FIG. 11, one of the remote devices is, for example, switch control device 220. The switch control device can control wall switch, lamp switch, and light switch. The switch control device comprises a plurality of switch control modules 1100. Each control module controls one switch. The control module 1100 includes a power line interface 1102 and a control module 1101.

Generally, the communication between the main control unit and the switch module is implemented by the power line communication network 200. The main control unit sends control signals to the switch module and the module will control the state of switch. With the main control unit, a user may control the switch module by the remote controller. Further, the switches can be programmed to go on and off at scheduled times. On the other hand, the user may control the switch module at remote location over the Internet if the system 10 is connected to the Internet by broadband or by dial-up phone line. There is no limitation on the number of the modules, and the number can be changed, as required by the user.

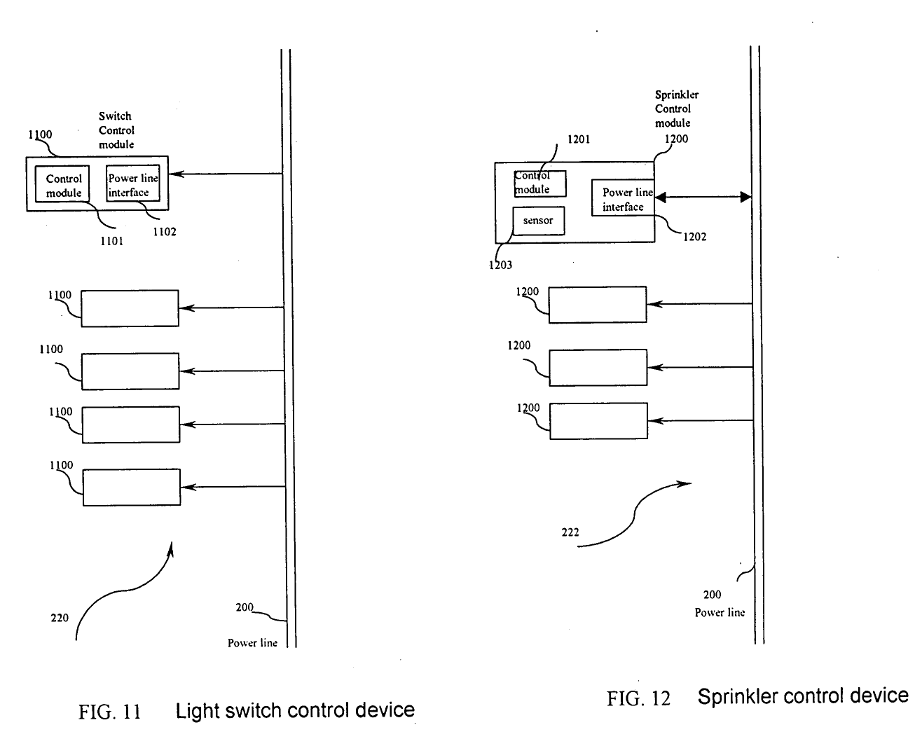

Turning to FIG. 12, one of the remote devices is, for example, sprinkler control device 222. The sprinkler control device comprises a plurality of control module 1200. The control module 1200 includes a power line interface 1202, a flow sensor 1203, and a control module 1201.

Based on the present invention, the sprinkler control device 222 communicates with the main control unit via power line communication home network. The power line interface receives the control signals from the main control unit. The sensor data will be transferred from the sensor 1203 to the power line interface 1202. Finally, the control module coupled to a sprinkler receives the control signals to control the sprinkler. A user may control and program a home irrigation system, such as sprinkler, using remote controller local or remote PC over the Internet by controlling valve of sprinkler open or close according to a watering cycle.

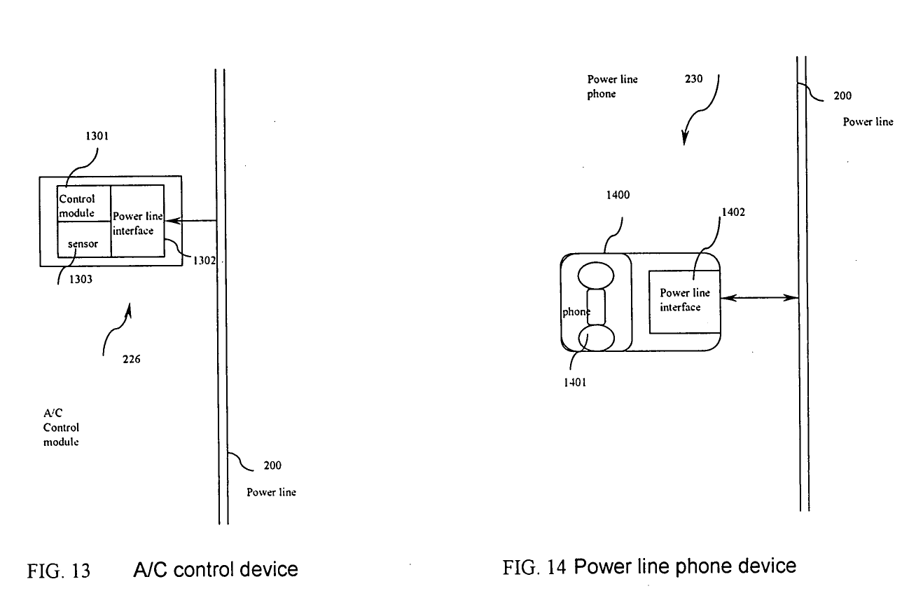

Turning to FIG. 13, one of the remote devices is, for example, air conditioner control device 226. The A/C control device 226 comprises a power line interface 1302, a sensor 1303, and a control module 1301.

Preferably, air conditioner control device 226 communicates with the main control unit via power line communication home network. The power line interface 1302 receives the control signals from the main control unit. The control module coupled to home air conditioner will receive the control signals to control home air conditioner. On the other hand, the sensor data will be transferred from the sensor 1303 to the power line interface 1302. A user can program and control home air conditioner using the sensor data from the sensor 1303. Additionally, the user can send control commands to the device by remote controller or over the Internet if the system 10 is connected to the Internet by Broadband or dial-up connection. For example, the user can control home air conditioner existed by the air conditioner control device 226. With the temperature sensor data received via power line home network, the user can program and control the air conditioner control device 226 and the main control unit sends a control command to the air conditioner through the air conditioner control device 226.

Referring now to FIG. 14, one of the remote devices is for example, power line phone 1400. It comprises a phone 1401 and a power line interface 1402.

By utilizing a power line communication network, the system 10 allows user to add a power line phone device anywhere there's an AC outlet. Power line phone eliminates the need to run additional phone lines at home. Just plug the extension power line phone jack into electrical outlet, all phone devices are going to work.

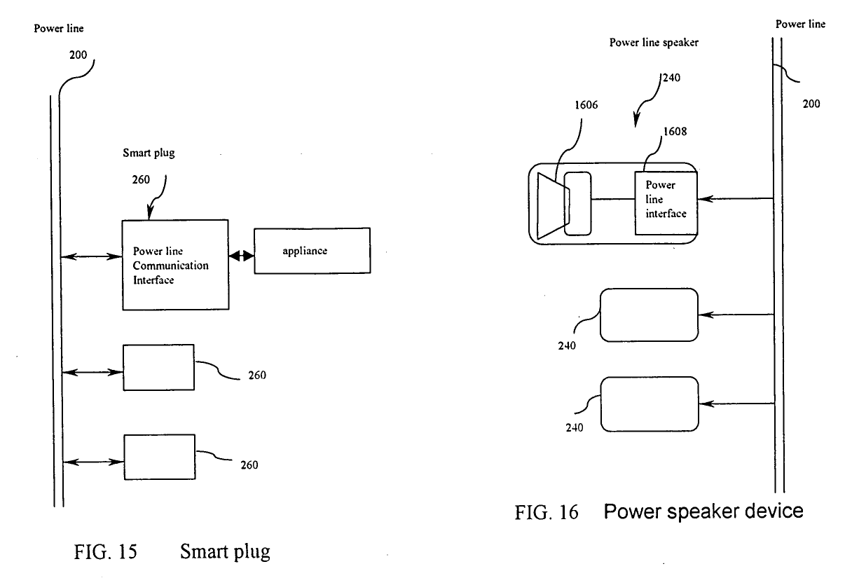

Referring now to FIG. 15, one of the remote devices is, for example, smart plug device 260. The smart plug device comprises a power line interface. The power line interface is capable of transmitting audio, video, and control data from the appliance to the main control system via power line communication link. The appliance includes VCR player, DVD player, camera, and other home electronic devices. Further, there is no limitation on the number of the smart plug device 260, and the number can be changed, as required. By utilizing the smart plug device 260, any home electronic devices can be connected to the home power line network.

Referring again to FIG. 16, one of the remote devices is, for example, power line speaker 240. It comprises a speaker 1606 and a power line interface 1608. The power line speaker 240 receives audio signal via home power line communication network. With power line speaker, a user can receive Hi-Fi audio anywhere in the home by power line speaker without additional new rewiring.

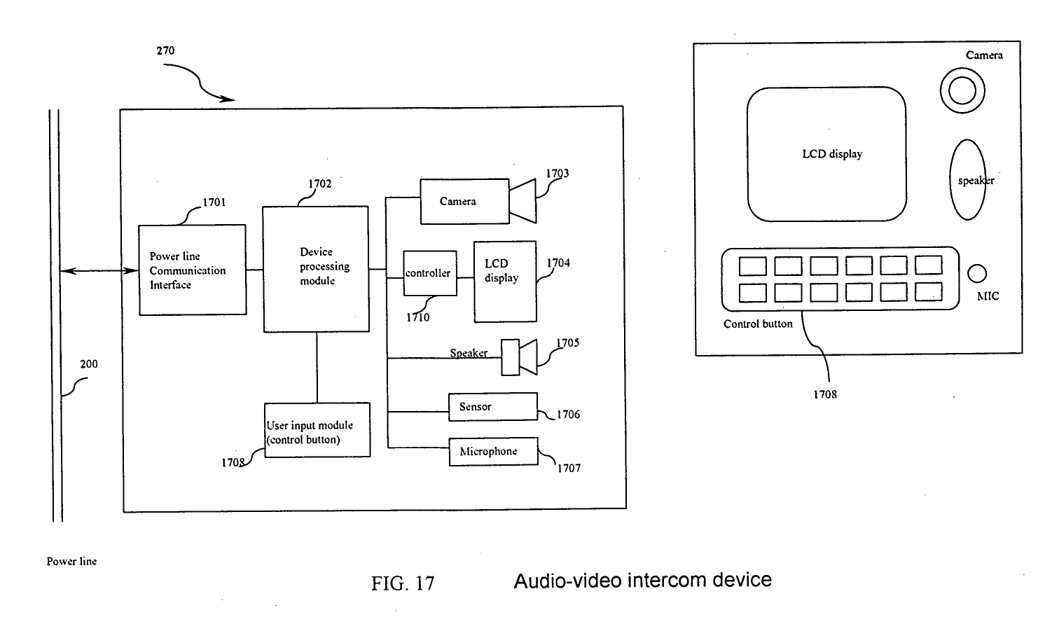

Turning to FIG. 17, one of the remote devices is, for example, audio-video intercom device 270. The audio-video intercom device comprises: a power line interface 1701; a device processing module 1702; a camera 1703; a LCD display 1704; a speaker 1705; a sensor 1706; a microphone 1707; controller 1710; and control buttons 1708.

As illustrated in FIG. 1 and FIG. 17, the system 10 also includes at least one audio-video intercom device for providing a means by which to allow a user to communicate with the persons present in, or occupants of, the home. The audio-video intercom device can also work as video conferencing device via a power line communication network.

Generally, the user can program the system 10 to set the audio-video intercom devices into a bi-directional audio-video transmission network such that various audio-video intercom devices connected to the power line communication network may transmit audio and video data to each other. For example, first audio-video intercom device can communicate with second audio-video intercom device via power line communication. Furthermore, the audio-video intercom device 270 can communicate with the main control unit 100 or cell phone 283 or remote audio-video device over the Internet, such as PC.

Referring again to FIG. 17, the first audio-video intercom device 270 communicates with the main control unit or second audio-video intercom device or other device, such as audio device 275, remote PC, in FIG. 1 via power line interface 1701 over the power line communication network 200. The camera 1703 and the microphone send video and audio data to the device processing module 1702. On the other hand, the device processing module receives the user commands or the commands from the main control unit to control the intercom device. The audio and video data received via power line interface from the main control unit or from second audio-video intercom device or from other devices are transferred to the device processing module 1702. The module will process the data and send the data to the LCD display 1704 via the control 1701 and the speaker 1705. Additionally, when the sensor 1706 is triggered, the camera will be active to send image data to the device processing module, and the sensor signal is also sent to the device processing module. The communication between the first audio-video intercom device and second audio-video intercom device or between first audio-video intercom device and the main control unit is implemented at full duplex or half duplex data transmission.

The user input module 1708 connected to the device processing module 1702 is configured to receive the user commands such that which audio-video device is going to select.

By utilizing the audio-video intercom device, the system 10 allows a user to safely identify visitors without opening the door by the audio-video intercom device, such as video door phone. The audio-video intercom device is designed to give the user full communication capabilities with a visitor. The audio-video intercom device installed outside the door communicates with the main control unit 100 via power line communication or wireless if it needed. When the visitor presses call button on the audio-video intercom device, a chime will ring and the LCD screen of the display device will display a live video image of a guest. The user can also see the guest via 4″ flat screen indoor audio-video intercom device. If the user wants to talk to the visitor, simply push the control button of the audio-video intercom device or cordless phone to begin speaking. The outdoor device's built-in microphone will pick up the visitor's voice automatically. The user can also answer the door by the main control unit, without having to physically open the door! Additionally, the user can answer the call from any audio-video intercom device or audio device using the other audio-video device or audio intercom device. Further more, the user may answer the call over the Internet.

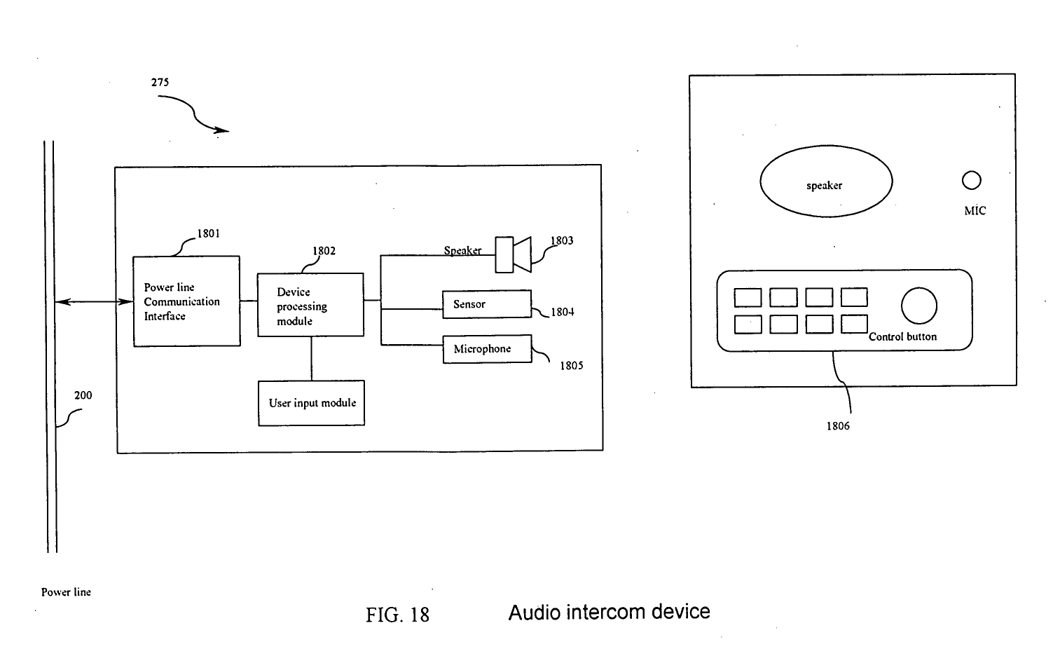

Turning to FIG. 18, one of the remote devices is, for example, audio intercom device 275. The audio intercom device comprises a power line interface 1801; a device processing module 1802; a speaker 1803; a sensor 1804; a microphone 1805; and control buttons 1806.

Based on the present invention, the system 10 provides one or more audio intercom device 275. With the audio intercom device 275, the system 10 also allows a user to safely identify visitors without opening the door. The first audio intercom device can communicate with second audio intercom device via power line communication network. The audio intercom device can also communicate with the main control unit 100 or any audio-video intercom device or remote PC over power line communication. The audio intercom device installed outside the door communicates with the main control unit 100 via power line communication or wireless if it needed. The user can answer the call from any audio intercom device or audio-video device using the other audio intercom device or any audio-video device. Further more, the user may answer the call over the Internet.

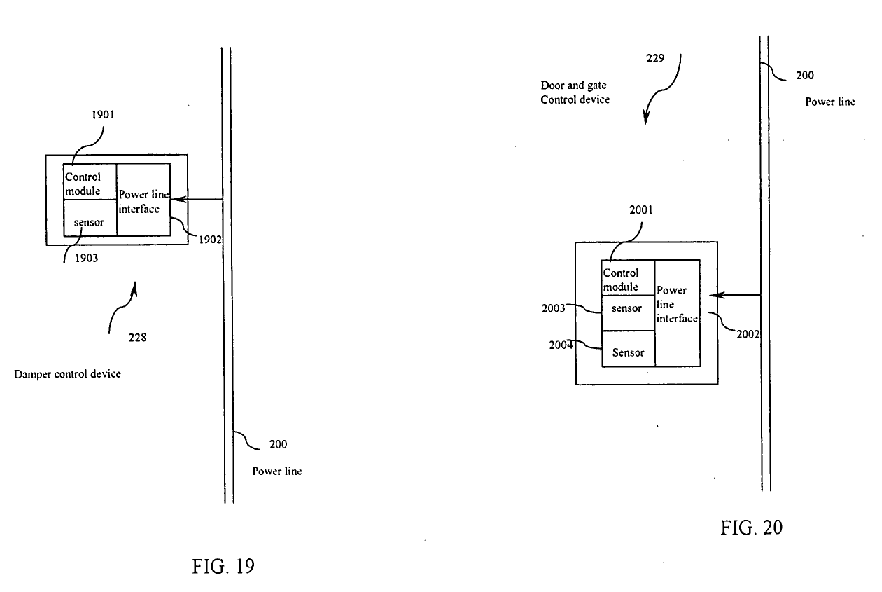

Turning to FIG. 19, one of the remote devices is, for example, damper control device 228. The damper control device 228 comprises a power line interface 1902, a sensor 1903, and a control module 1901.

Preferably, the damper control device 228 communicates with the main control unit via power line communication home network. The power line interface 1902 receives the control signals from the main control unit sent by a home user. The control module coupled to the home damper device will receive the control signals from the power line interface 1902. On the other hand, the sensor data will be transferred from the sensor 1303 to the power line interface 1302. The main control unit 100 will receive the data via the power line communication. Based on the data received from the device 228, the main control unit will control the damper device. The home user can program and control damper control device. Additionally, the user can send control commands to the device by remote controller or over the Internet if the system 10 is connected to the Internet using Broadband or dial-up connection.

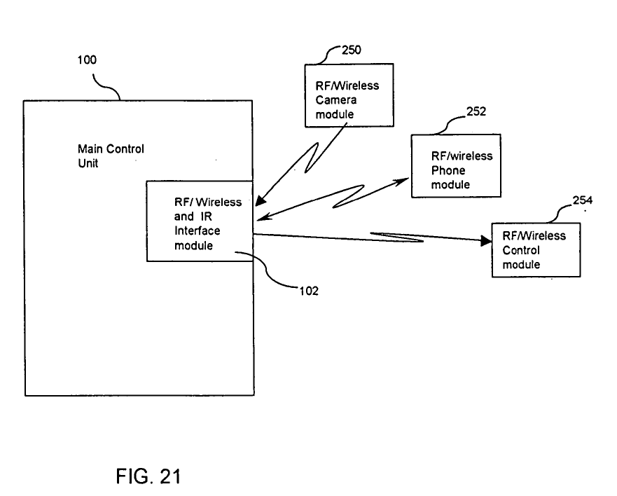

Turning to FIG. 20, one of the remote devices is, for example, door and gate control device 229. The door and gate control device 229 comprises a power line interface 1902, a contact sensor 1903, a motion detect sensor 2004, and a control module 1901.

Generally, there is one or more door and gate control device 229 provided in the system 10. The door and gate control device receives control signals from the main control unit sent by a home user or the main control unit 100 via power line home communication network. The power line interface module 2002 receives the signals and sends the signals to the control module 2001. Based on the signals received, the control module will control the user home door or gate. Additionally, the sensor data form sensor 2003 and 2004 will be transferred to the main control unit.

FIG. 21 illustrates three wireless remote devices interacting with the main control unit. The devices include RF/wireless camera module 250, RF/wireless phone module 252, and RF/wireless control module 254. Further, there is no limitation on the number of the modules, and the number can be changed, as required.

The RF/wireless camera module 250 can send video data to the main control unit 100 via RF/wireless communication link. A user can watch live image from the RF/wireless camera module 250. Further, the user can also watch the live image at remote location over the Internet.

The two way audio data can be transferred between the RF/wireless phone module 252 and the main control unit. By utilizing the RF/wireless phone module 252, a home user can talk to his/her friends via the main control unit over RF/wireless communication link. For example, the user can talk to the people in the same house or other city. In addition, the user can talk to people over the Internet if the system is connected to the ISP.

Based on the present invention, the RF/wireless control module 254 can receive the control signals sent by the user over wireless communication link. In response to the control signals, the module can control many appliances, such as switch, and door lock. The user can also control the module at remote location over the Internet.

Turning again to FIG. 1 and FIG. 2, the system and method of the present invention can be implanted as a computer software program. The software program is utilized in conjunction with the hardware, such as the microprocessor 150, memory 107, and hard drive 106. Additionally, the software program can be programmable so as to provide for the modification of same, if desired.

There are many application software provided with the system. The application software storing at the hard drive 106, in FIG. 2, at the main control unit controls the flow of data to and from the main control unit through the audio-video controller interface module 104, the RF/wireless and IR interface module 102, and the power line communication interface module 101.

On the other hand, the system software is provided. The system software is configured to provide operating system services such as job scheduling, task management, hardware control, and memory management.

The system software includes one of: DOS, Windows CE, Windows 98/2000/XP, and embedded LINUX.

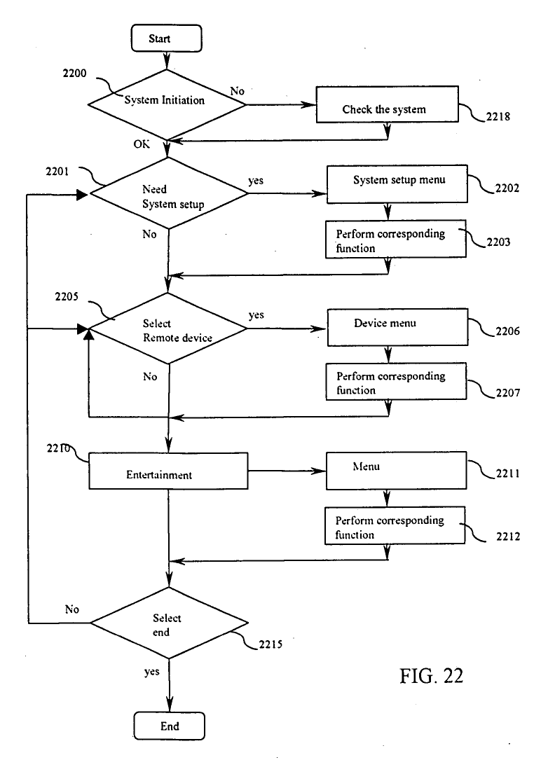

FIG. 22 is a flow chart showing a method of implementing the present invention for home entertainment, security, surveillance, and automation control system over home network communication link and selecting operation of the system. The main control unit 100, in FIG. 1, carries out the selection operation process.

In FIG. 22, first of all, a step 2200 is the system 10 initiation. The system decides whether or not the plurality of remote devices, user input devices, modules, and other devices coupled to the main control unit 100 are working. If the decision in the step 2200 is NO, the system decides to ask a user to check the system 10. On the other hand, if the decision in the step 2200 is OK, the selecting operation process advances to next operation, a step 2201.

Next, if the step 2201 is confirmed that the system setup is needed, the main control unit goes to a system setup program and performs corresponding function. The home user can input further command by pressing corresponding button provided on a remote controller or other input device. If it is found in the step 2201 that there is no need to setup the system 10, the main control unit further checks where or not the user selects a remote device, a step 2205.

If it is confirmed that the user wants to select a remote device, the selection operation process advances to a step 2206 and 2207. On the other hand, if the decision in the step 2205 is NO, the control of the system goes to a step 2210.

After the selecting process goes to entertainment, the main control unit further checks whether the user has inputted a user command and perform corresponding function, such as play TV or DVD or Radio.

Finally, the selection operation process ends if the decision in the step 2215 is YES. If it is confirmed in the step 2215 that the select end does not selected, the selection operation process advances to the step 2201 or 2205. There are two ways for the system to record audio and video signals such as live image from the remote control device or the tuner device or DVD random access memory. One is to let hard drive in the mass storage device to record and second is to send audio and video data and control data to VCR. The home user may use is power line communication interface device to connect to VCR so the VCR can be controlled to play or record program. The system can also receive audio and video data from VCR.

A method of operating said system includes one of said plurality of remote devices receiving control signal from said main control unit, wherein said control signals comprising: switch, lamp, A/C, door, gate, and damper control signal.

A method of operating said system comprises a user is capable of adding or deleting one of said plurality of remote devices.

A method of said main control unit receiving video, audio, and control data from each remote devices via said communication link, the method comprising: a user setting a predetermined priority level to each remote device capable of sending said data to said main control; said main control unit receiving high priority level data first; and said LCD display displaying said data.

A method of said main control unit receiving video, audio, and sensing data from various remote devices via said communication link to said main control unit, the method comprising: a user setting a predetermined priority level to each remote device capable of sending said data to said main control; said main control unit receiving said data from high priority level first; and said LCD display displaying said data.

A method of operating a remote device for transferring video, voice, and data via said communication link to said main control unit, the method comprising: displaying said system control menu on said display device of said system; selecting one or more remote device; setting said remote device, wherein said method of setting said remote device comprising: an interrupt, a polling, and a custom.

The remote device, such as the baby watcher device 210, the childcare device 211, and more can be operated at three modes, such as On-mode, Interrupt-mode, and User controlled mode.

Further, it is to be understood that the present invention is not limited to these embodiments, but various variations and modifications may be implemented by those skilled in the art without departing from the scope of the invention.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A system for home entertainment, security, surveillance, and automation control comprising:
a plurality of remote devices for generating audio, video, and/or sensor data and receiving control data;
a main control unit capable of receiving commands from a user, transmitting said data to and from at least one of said plurality of remote devices, and controlling and programming said system;
a display device coupled to said main control unit; and
a communication link connected to said remote devices and said main control unit, wherein said communication link is capable of transferring data between said main control unit and at least one of said plurality of remote devices.

2. The system of claim 1, wherein said communication link includes power line communication home network.

3. The system of claim 1, wherein said display device is capable of displaying text data and image from at least one of said remote devices or said main control unit or remote location over the Internet.

4. The system of claim 3, wherein said Display device further comprising: two stereo speakers capable of receiving audio data from said main control unit; and a camera capable of sending video data to said main control unit.

5. The system of claim 1, wherein said system further comprising a plurality of user input devices capable of receiving said user input commands and sending said commands to said main control unit to interact with said system, said user input devices comprising: a remote controller; a cell phone; and a wireless PDA.

6. The system of claim 1, wherein said main control unit coupled to said communication link, said main control unit configured to control said system and perform communication with at least one of said plurality of remote devices via said communication link to transmit video, audio, sensor and control data, further comprising:
a system and data bus for transmitting data; a microprocessor module connected to said bus;
a mass storage device having a flash memory, a hard disk driver, and a DVD random access memory coupled to said microprocessor via said bus and configured to record and store audio, video, and control data;
a tuner device coupled to said microprocessor via said bus and designed for receiving TV, cable TV, and Radio signals; an audio-video controller module coupled to said microprocessor, said mass storage device, and said tuner device via said bus, said controller module capable of receiving audio-video data or signals from said bus, said mass storage device, and said tuner device; a RF/wireless and IR interface module coupled to said bus, configured to transfer audio, video, and control data via said bus; and
a power line communication interface module coupled to said bus, configured to transfer the data over said communication link.

7. The system of claim 6, wherein said microprocessor including means for interpreting a command to control at least one of said plurality of remote devices, said modules, said tuner device, said mass storage device, and perform communication with at least one of said module and said device.

8. The system of claim 6, wherein said microprocessor determines a state of operation of said main control unit.

9. The system of claim 6, wherein said audio-video controller module capable of sending audio and video signals to said Display device and receiving video signal from said Display device.

10. The system of claim 6, wherein said RF/wireless and IR interface module capable of transmitting video, audio, control data between one of said user input device and main control unit, said RF/wireless and IR interface module configured to transmit wirelessly audio, video, and control data to and from at least one of said plurality of remote devices.

11. The system of claim 6, wherein said power line communication interface module capable of transmitting audio, video, and control data between at least one of said plurality of remote devices and said main control unit.

12. The system of claim 6, wherein said tuner coupled to said bus further comprising: a TV module; a cable TV module; and a Radio module.

13. The system of claim 6, wherein said main control unit further comprising: a memory coupled to said bus and capable of storing the system information; a hard drive connected to said bus and capable of storing operating system, application software, and a database of said remote devices; a power supply and battery module; and communication ports module coupled to said bus, wherein said communication port module including: DVI port; IEEE-1394 port; USB 2.0 port; RS-232 port; and a modem port.

14. The system of claim 13, wherein said communication port module further comprising an Ethernet port capable of transmitting data over the Internet and means for communicating audio, video, control data with power line communication link.

15. The system of claim 1, wherein said system further comprising a remote computer configured for communication with said system over external Internet network, said remote computer comprising a software capable of receiving audio, video, sensor data from said system and sending control data to said system.

16. The system of claim 6, wherein said main control unit interacts with one of said plurality of remote device via said communication link and said user input device for full duplex or half duplex data transmission.

17. The method of interacting with said main control unit using one of said plurality of user input devices, the method comprising the steps of selecting one of said plurality of user input devices, setting said main control unit to associated mode, selecting one or more said remote device, receiving data from said remote device, and outputting said data to said Display.

18. The system of claim 6, wherein said hard disk drive of said mass storage device configured to record audio and video data from at least one of said plurality of remote devices, and from said main control unit.

19. The system of claim 6, wherein said power line communication interface module comprising: one or more communication protocols such as power line home plug, X10, and CEbus ( ).

20. The system of claim 1, wherein said main control unit receives said home user command from one of: said remote control; said cell phone; and said wireless PDA.
